(19) United States
(12) Patent Application Publication
(10) Pub. No.: US 2005/0079853 A1
(43) Pub. Date: Apr. 14, 2005

(54) Broadcasting information about eligible network operators to mobile user equipments

(76) Inventor: Tuija Hurtta, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/495,970

(22) PCT Filed: Nov. 21, 2001
(86) PCT No.: PCT/EP01/13522

(51) Int. Cl. H04Q 7/20

(52) U.S. Cl. 455/403; 455/560; 455/561

(57) ABSTRACT

The invention proposes a system and method for providing an attachment or a connection in a communication network. A connection is established between a user equipment and another network element via a radio access network, and one or more of alternatively selectable support network elements of at least two operator networks, the radio access network element broadcasting information on types of support network elements of available operator networks to the user equipment.

### FIELD AND BACKGROUND OF THE INVENTION

The present invention relates to a system and method for providing an attachment or connection in a communication network. The communication network may be a pure data network, a network for transmitting data and/or other non-data type of information such as speech, or may be a network exclusively reserved for non-data information. The network can be a circuit-switched network, a packet-switched network such as a GPRS or UMTS network, or may consist of a combination of networks of different type.

When providing a connection in a communication network, usually several network elements are involved, including the connection originating network element, the connection terminating network element and/or one or more intermediate network elements such as a base station, a base transceiver station, a base station controller and/or one or more support nodes handling the signalling and/or user traffic.

As an example, in a GPRS-based or UMTS-based network, a connection (e.g. call) originating from, or terminating at, a user equipment (UE) such as a fixed or mobile equipment or mobile station (MS) is made to a connection terminating or originating equipment using a radio network controller (RNC) which communicates with a support entity such as a SGSN (Serving GPRS Support Node) and possibly a GGSN (Gateway GPRS Support Node). The connection terminating and originating equipments can be located in the same or a different network. In particular, in case of mobile user equipments, the actual location thereof is defined with a resolution of a routing area (e.g. in idle state) or with a finer resolution of a cell (e.g. when handling a connection such as a call). Note that Routing Area (RA) is a standard term used in conjunction with GPRS, while GSM and UMTS circuit-switched systems use the term Location Area (LA). In both cases, the area is referring to the area where a mobile station is registered in the serving node (e.g SGSN or MSC/VLR), and where eventually the serving node pages the mobile station to establish connection. In this application, the term area will be used to refer to location area and/or routing area.

The coverage area of an entire network is usually divided into several areas (RA or LA), with one area (in a GPRS-or UMTS-based network) being assigned to one serving node (one serving node typically handling many areas). When having information on the area where the user equipment is presently located, the serving node in charge of handling a connection to or from this user equipment is unambiguously defined.

For example, in GSM and UMTS, this one-to-one correlation between the routing or location areas and the assigned SGSNs or MSC/VLRs may, however, be of disadvantage e.g in case of break-down of an SGSN or an MSC/VLR or necessary maintenance operations such as software updating. In such a case, the routing area or the location area has to be completely shut-down and is at least temporarily no longer usable for providing connections.

This situation may be significantly improved when changing the network structure in such a manner that at least two serving nodes such as two SGSNs or two MSC/VLRs are able to handle the same routing or location area. In such a case, e.g. a base station controller (BSC) or radio network controller (RNC) may use different interfaces to the serving nodes such as Iu and/or Gb and/or A.

The provision of two or more support nodes serving the same area provides several advantages such as resilience by enabling an RNC (possibly having a list of available SGSNs) to use another SGSN if the previously used SGSN should become overloaded or out of order. Furthermore, maintenance operations such as software updates can be effected without shutting down the area. In addition, the network signalling caused by inter-SGSN handovers can be reduced.

As an example, several SGSNs may be provided for covering a metropolitan area such as London area, and a mobile station moving around the city can always use its-original SGSN for handling connections.

For instance, an IP network may be introduced on an interface such as Iu interface which presently is mainly used as a point-to-point Iu interface between the RNC and the SGSN. When introducing an IP network or network of some other appropriate type on the Iu interface, one RNC may be connected to several SGSNs.

In a case where one network element (which e.g. is in charge of controlling the radio connection to a user equipment) is able to connect to different support nodes being alternatively provided, there exists a problem in finding and selecting an appropriate support node, for instance an SGSN to be used for a signalling connection. This signalling connection may e.g. be used to transfer L3 (layer 3) messages (such as mobility management MM and session management SM) between the user equipment (e.g. MS) and the support nodes such as SGSN. Furthermore, in case of inter-support node location update the new support node would benefit from finding the old support node which was serving the user equipment until location update. Note that in UMTS, handover (i.e. serving RNS relocation) happens so that the old node selects a new node. In location update, the new node has to find the old node e.g. to get MM and PDP contexts of the UE. In GPRS/UMTS, location update=routing area update.

### SUMMARY OF THE INVENTION

The present invention provides a solution for solving or at least relieving the above problems either partly or entirely.

According to one aspect, the invention provides a system as defined in claim 1. This system may consist of a whole network, may be only a part of a network, or may comprise two or more networks.

According to a further aspect, the invention provides a method as defined in the independent method claim.

According to a preferred aspect of the invention, the radio access network is adapted to broadcast, to the user equipment(s), information on available operator network(s) or support network element(s), wherein the broadcast information includes information on the generation type of the support network elements. The user equipment is adapted to receive the broadcast information and to send selection information to the radio access network for selecting an operator network and/or a support network element.

In a preferred embodiment, a UE is adapted to select from different network operators which parallely provide attachment and connection services for establishing calls or other types of connections.

The broadcast information may include area identifiers of the operator networks, preferably Location or Routing Area Identifiers (LAIs/RAIs) or mobile country codes and/or mobile network codes of the operator networks, and/or identifiers for identifying available support network elements. The broadcast information also includes information on the generation type of the support network elements. In a preferred implementation, the user equipment is preferably adapted to receive only that part of broadcast information which is intended for the generation type of the user equipment.

The RNC/BSC may broadcast multiple area identifiers per cell. Every area identifier preferably includes the mobile network code to identify the core network operator.

The support network elements can be serving nodes, preferably SGSNs. The radio access network element can be a Radio Network Controller or a Base Station Controller.

At least one of the network elements, e.g. a radio network controller or a base station controller or a DNS server, preferably stores a list of support network elements of the operator networks, said list including information on the generation type of support network elements and being accessible by the radio access network using an identifier identifying an area and/or an identifier identifying a mobile network code, or a desired support network element.

### BRIEF DESCRIPTION OF THE DRAWINGS

FIG. 1 shows a basic structure of one embodiment of a system in accordance with the invention;

FIG. 2 illustrates the message flow for establishing a connection between a user equipment and a serving node of a selected operator;

FIG. 3 shows steps of another method for selecting a serving node of a desired operator;

FIGS. 4 and 5 illustrate message flows in system and methods according to further embodiments of the invention; and

FIG. 6 illustrates a list of available support entities.

### DETAILED DESCRIPTION OF PREFERRED EMBODIMENTS OF THE INVENTION

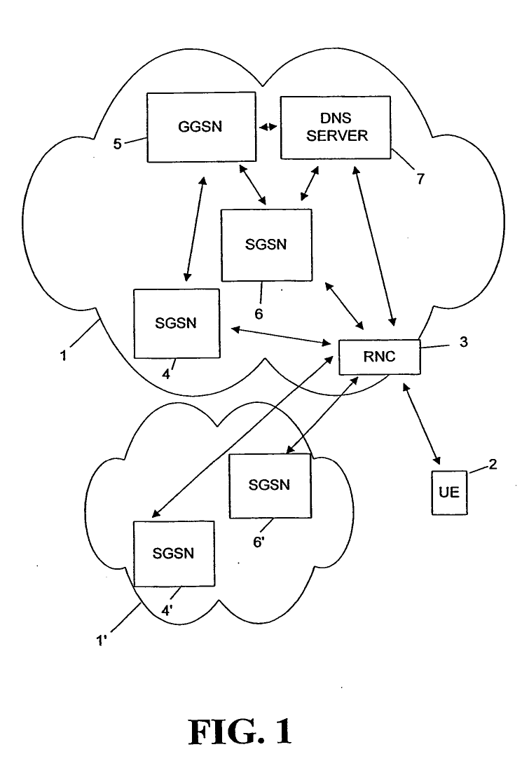

FIG. 1 shows the basic structure of an embodiment of a system in accordance with the invention. The system includes two or more networks 1, 1′, or forms a part thereof. The network 1 can connect to at least one, or usually a plurality of, user equipments (UE) 2 which, in this embodiment, are implemented as mobile stations. The user equipments may also be of any other type of equipments such as stationary terminals. Although only one user equipment 2 is shown, usually several user equipments are attached to the network 1 and represent connection originating or terminating equipments.

In case of connection, or connection set-up, with another equipment forming part of network 1 or of another network, a radio connection to user equipment 2 is provided and handled by a radio access network (RAN). The RAN comprises, in this embodiment, a radio network controller (RNC) 3 which is part of, or represents, the radio access network for radio connection to user equipment 2. Usually, several radio access networks and controllers 3 may be provided in the networks 1, 1′ for radio coverage of the different areas of the networks 1, 1′. The RNC 3 (first network element) may be selectively connected to different serving entities, e.g. nodes which, in this embodiment, are implemented as SGSNs (Serving GPRS Support Nodes) 4, 4′, 6, and 6′.

The network may comprise additional or alternative serving nodes such as mobile switching centres (MSCs) which normally will be combined with visitor location registers (VLRs). The serving nodes 4, 4′, 6, 6′ may be connected, if necessary, to a gateway node which can be implemented as GGSN (Gateway GPRS Support Node) 5 and provides the possibility of connection to other networks.

In addition, a DNS (Domain Name System) server 7 may be provided which may form part of network 1 or may be a network-external component. The DNS server 7 can be accessed by RNC 3, and usually also by other network components such as serving nodes 4, 6 and/or gateway node 5. The communication possibilities are shown in FIG. 1 by means of double-headed arrows.

The invention additionally provides, according to a further aspect, one or more network elements equipped so as to implement the hardware structure or functions usable in a network or connection or selection method as defined in the claims and/or described in the present specification.

The present invention provides a solution for allowing a UE to decide on an operator to be used, wherein a radio access network element such as a radio network controller or base station controller can decide which support node (e.g. SGSN) of the selected operator is to be used for attachment or connection (e.g. signalling connection and/or user traffic connection). A signalling connection can be provided for transferring messages such as L3 messages, e.g. MM and SM, between a network element such as a user equipment, e.g. MS, and the support node. Hence, the access network element may be alternatively connected to different support nodes serving e.g. the same area, e.g. routing area.

In accordance with the invention, area identifiers such as “Routing Area Identity (RAI)” of different operators may be used by the user equipment or access network element (e.g. RNC) to detect or derive a list of alternatively selectable operators. In this list different support nodes of the operators may be identified by their addresses. This list may be preconfigured inside the RNC.

Basically, for RAN sharing, the UE is able to indicate to which core network it wants to connect to. The UE can do that because it will be informed on which core networks are available. The UE can detect the available core networks e.g. by deriving the available mobile network codes from the broadcasted RAI or LAI. The UE then may send the selected mobile network code to the RNC/BSC in order to get connected to the selected core network.

It may be possible that both 2G and 3G core networks are available. This is the case e.g. in GERAN, where it is possible to connect either to a 2G or 3G core network from one cell. In order to select the appropriate core network (2G or 3G), the RNC/BSC should also indicate which core networks are 2G and which are 3G. This is possible by specifying the broadcasted RAIs or LAIs as information which is only read or readable by 2G UEs or by 3G UEs. As an alternative, the RNC/BSC could broadcast 2G/3G information together with a RAI or LAI, but in this case, the broadcast information is increased.

This implementation of the invention uses the RAI/LAI information to derive the available mobile network codes.

As another alternative only one type of broadcast is sent to UE (both 2G and 3G) and the RNC then recognizes if an incorrect type of UE tries to attach to an inappropriate type of CN. The RNC then corrects the information and overrides the choice of the UE.

The derivation of Mobile Network Codes (mncs) from RAIs is one possible solution alternative.

MS is informed on which interfaces are supported by each operator. And clearly only A/Gb capable MS can not access CN through Iu interface.

New 2G LAIs/RAIs may be added to new SI (System Information) messages that only new MS will read.

The proposed solutions are able to provide RAN sharing in GERAN. Moreover the invention can be applied elsewhere as in RAN sharing.

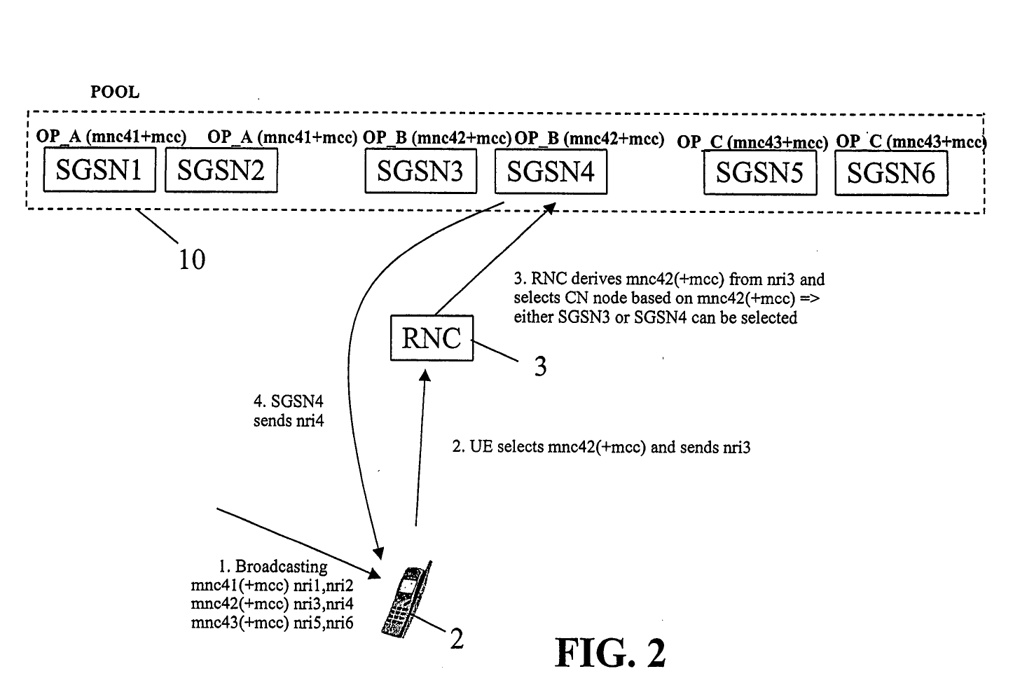

FIGS. 2 to 5 show different embodiments for implementing RAN sharing by multiple networks, e.g. CN operators OP_A, OP_B, OP_C.

The CN operators OP_A, OP_B, OP_C comprise at least one support node, e.g. SGSN or MSC, connected to the RAN, e.g. to RNC 3. In the illustrated embodiments, two support nodes SGSN1, SGSN2, SGSN3, SGSN4, SGSN5, SGSN6, preferably of different types such as second generation type (2_G) or third generation type (3_G) of each CN operator OP_A, OP_B, OP_C are shown to provide a pool 10.

Each CN operators OP_A, OP_B, OP_C has its own identifier “mnc41”, “mnc42”, “mnc43” (mnc, mobile network code),as shown in the drawings. Further, each CN operators OP_A, OP_B, OP_C comprises, in this embodiment, two support nodes SGSN1, SGSN2; SGSN3, SGSN4; SGSN5, SGSN6, but may of course include only one or more than two support entities.

FIG. 2 shows another way of RAN sharing by multiple CN operators. Location areas and routing areas are configured by the RAN operator.

According to FIG. 2, the network(s) are broadcasting not only identifiers, e.g mnc41, mnc42, mnc43, of the operator networks but also additional identifiers nri (nri1 to nri6) (nri=Network Resource Identifier) for identifying the support nodes (SGSN1 to SGSN6) of the respective networks. Thus, the information mnc41 nri1, nri2; mnc42 nri3, nri4; mnc43 nri5, nri6 is broadcast and received by the UEs 2 (step 1).

Step 2: UE 2 selects, in accordance with internal selection criteria such as the criteria mentioned above, e.g. mnc42 and sends the identifier nri3 to RNC 3.

Step 3: RNC 3 derives the operator code mnc42 from the received identifier nri3 and selects a CN node based on mnc42 and eventually based on nri3. If available and e.g. not overloaded, RNC 3 may select SGSN3 defined by the identifier nri3.

However, RNC 3 may also be designed to freely select any other available support entity of the operator network OP_B defined by the derived mnc code, for supporting the UE 2. Thus, in the latter case, either SGSN3 or SGSN4 can be selected. In this example SGSN 4 is chosen.

This alternative of free selection of a support entity for the UE 2 likewise applies to all other embodiment. The selection of an available support entity from the operator network defined by the identifier received by the RNC 3, e.g. nri or mnc, may be based on a selection criteria such as optimum distribution of actual support entities load, etc. The selection criteria may be contained in a selection criteria table or algorithm available to the RNC 3 or provided internally in the RNC.

Step 4: The selected support entity SGSN4 sends its identifier nri4 to the UE 2.

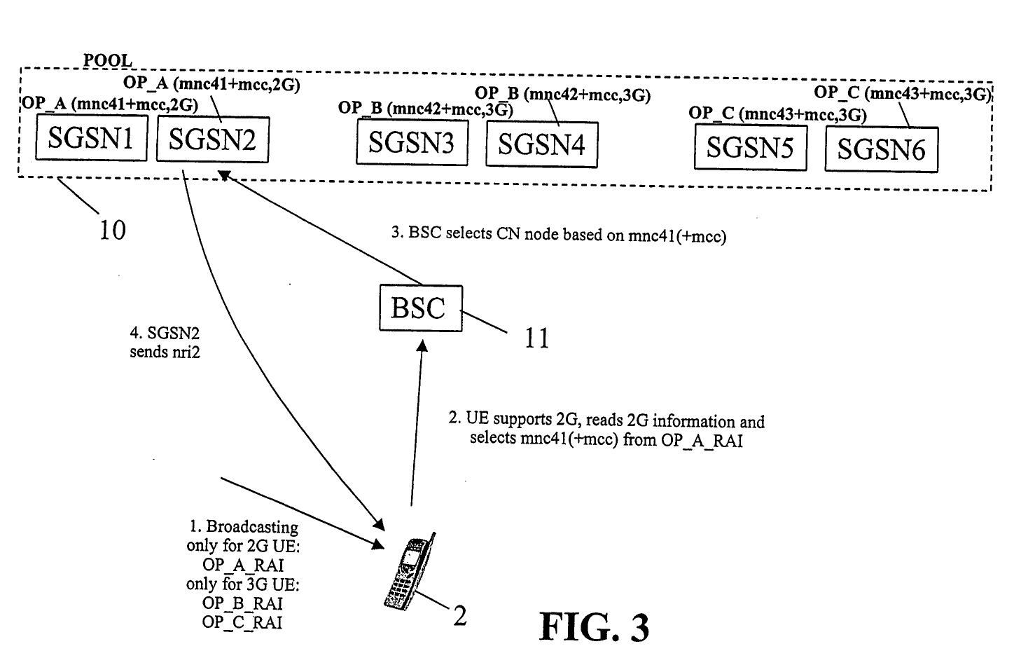

FIG. 3 shows an embodiment for providing RAN sharing in case of CN operators of different type or generation such as 2G/3G CN operators. The operator OP_A is of second generation type (2G) whereas the operators OP_B and OP_C are of third generation type (3G).

With this embodiment, 2G and 3G UEs can always select the appropriate core network (2G or 3G).

The operator OP_A (mnc41, 2G) comprises support entities SGSN1 and SGSN2 and is identified by (mnc41, 2G). The operators OP_B, OP_C comprise support entities SGSN3, SGSN4, and SGSN5, SGSN6, and are identified by the codes mnc42, and mnc 43, respectively (mnc42, 3G), (mnc43, 3G).

The RAN includes a BSC (Base Station Controller) 11 which broadcasts RAIs (Routing Area Identities). The broadcasted RAIs are sent with an identifier or frequency or other coding so as to distinguish between 2G and 3G information. Preferably, two types of IEs (Information Elements) are introduced which are broadcast for identifying the type of support node: IEs for 2G and 3G.

One or more Network Resource Identifiers (nri) is allocated to a CN node.

Step 1: The RAN (BSC 11) is broadcasting only for 2G UE:
OP_A_RAI,
   and only for 3G UE:
OP_B_RAI
OP_C_RAI.

Step 2: UE 2 supports, in this example, 2G, reads only 2G information, i.e. OP_A_RAI. RAI consists of mobile country code, mobile network code and routing area code, so UE 2 is able to select the mobile network code mnc41 from OP_A_RAI. The UE 2 sends this mobile network code mnc41 to the RAN.

Step 3: BSC 11 selects based on mnc41 one of the CN nodes SGSN1, SGSN2.

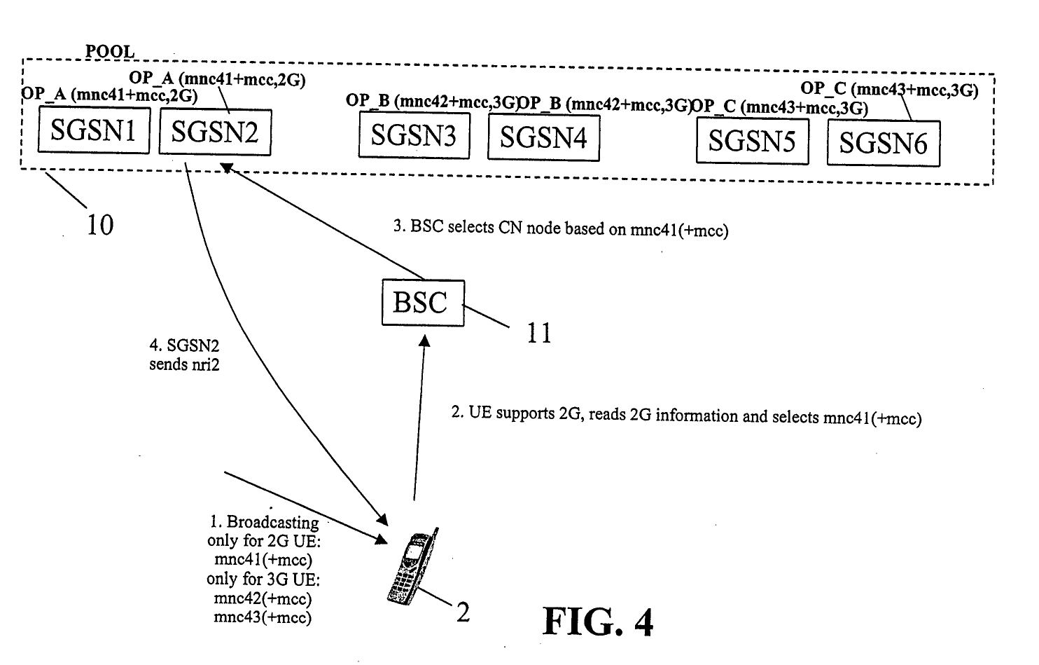

Step 4: The selected SGSN2 sends its identifier nri2 to the UE 2. _In the embodiment of FIG. 4, similar to FIG. 3, RAN sharing is provided with different 2G/3G CN operators.

Step 1: The RAN is broadcasting per a cell belonging to a location area or routing area only for 2G UE:
mnc41,
   and only for 3G UE:
mnc42
mnc43.

Step 2: The UE 2 supports 2G, reads 2G information and selects the only offered 2G identifier mnc41.

Step 3: The BSC 11 selects a CN node SGSN2 based on the identifier mnc41 sent from the UE 2.

Step 4: The selected SGSN2 sends its identifier nri2 to the UE 2.

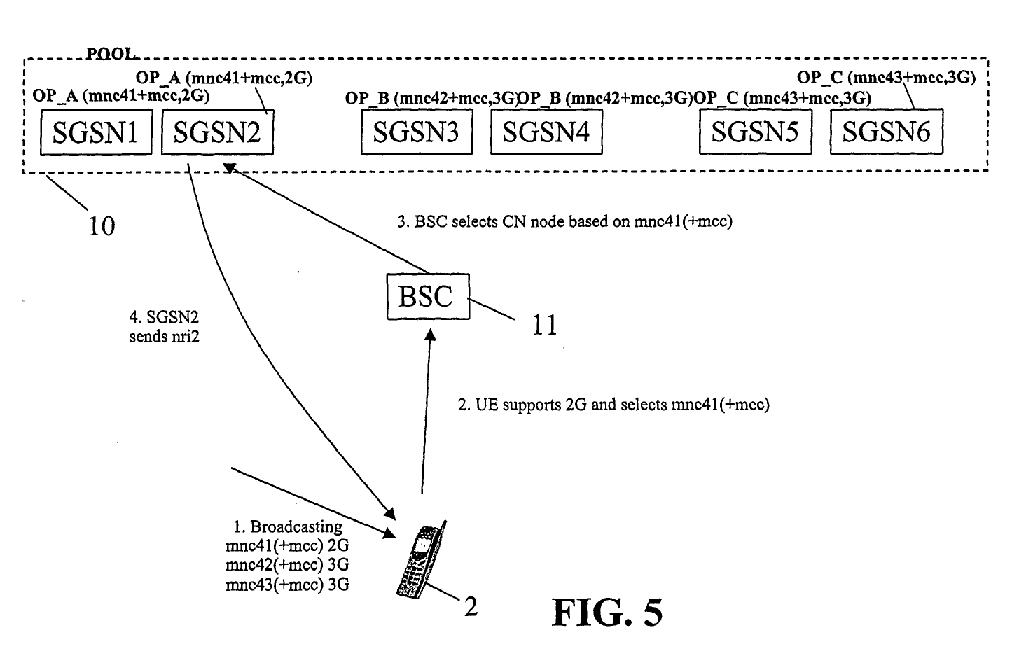

In the embodiment according to FIG. 5, RAN sharing is provided for 2G/3G CN operators. Generation information (2G/3G) is broadcast together with core network operator information (mnc).

Step 1: The RAN is broadcasting mnc41 2G; mnc42 3G; and mnc43 3G.

Step 2: UE 2 supports 2G and therefore selects mnc41. The selected identifier mnc41 is sent to the BSC 11.

Step 3: BSC 11 selects based on mnc41 a CN node of OP_A, e.g. SGSN2.

Step 4: The selected SGSN2 sends its identifier nri2 to the UE 2.

Note that, for all embodiments, the further details regarding selection criteria, subsequent transmissions between UE 2 and the selected support entity etc. may be identical or similar to the above described detailed explanations.

The radio network controller or base station controller or DNS server 7 or any other entity of the networks preferably comprises, or has access possibility to, a memory (not shown) storing lists (tables) of serving nodes available for alternatively covering routing areas or location areas of the networks.

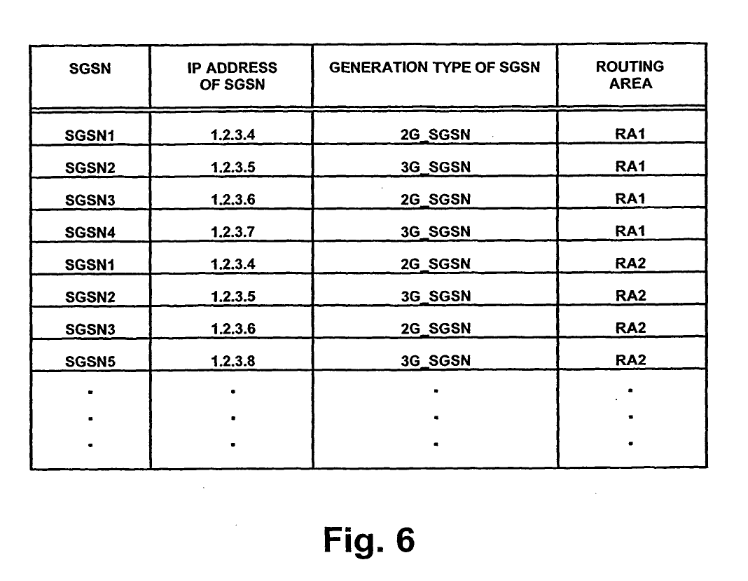

FIG. 6 shows an example of a table stored in the memory. According to this example, the table contains several columns and rows. The left column “SGSN” lists the available serving nodes. SGSN1 may correspond to SGSN 4, SGSN2 may correspond to SGSN 6, and SGSN3, SGSN4 may correspond to SGSN 4′, SGSN 6′, or further serving nodes not shown in FIG. 1 and covering other routing or location areas of the network 1. The table furthermore contains a column “IP address of SGSN” listing the IP addresses of the individual available serving nodes. The column “Type of SGSN” or “(SGSN identifier)” lists the identifiers identifying the types of the individual serving nodes. In this example, the type of the node (2G or 3G) is represented by the identifier. The column “Routing Area” lists the routing areas or location areas being covered by the individual serving nodes. As an example, the serving nodes SGSN1 SGSN2, SGSN3 and SGSN4 are available for covering the same first routing area RA1 whereas the serving nodes SGSN1 SGSN2, SGSN3 and SGSN5 are available for alternatively covering a second routing area RA2 in which a mobile station may be located, e.g. after moving thereto from routing area RA1. The table may be stored in the RAN or other control element for providing the information on the generation type to be broadcast.

The support network elements may also be MSCs (Mobile Switching Centres) or other types of serving elements, e.g. in circuit-switched networks.

The solutions provided by the present invention are preferably applicable in a case where network elements of different generation (such as 2G SGSN and a 3G SGSN) are provided which handle the connections for the same area, e.g. routing area. The selection of the support node may be made depending on the type of the connection established and/or requested, or on the type of the user equipment. As an example, the invention may be employed in a GERAN system (GSM/EDGE radio access network).

The present invention allows an effective adaptation of a cellular network being at least partly e.g. IP-based. IP networks are essentially peer-to-peer structured whereas the conventional cellular networks such as GSM, UMTS, etc. are typically based on an hierarchical architecture wherein a radio access network (RAN) or, in more detail, a controller controlling the radio access such as a RNC, RNS, BTS, BSS and the like, is handled by a single serving node (e.g. MSC/VLR; SGSN; . . . ).

The invention generally proposes a structure and method wherein one network element providing e.g. radio access (e.g. RAN) to a user equipment is connected to many serving nodes such as core network (CN) nodes. This reduces the number of inter-CN-node-area update procedures and increases the reliability. The invention hence proposes a new architecture for a cellular system wherein one radio access network (or the network element providing or controlling the radio access) as well as a location area (LA) or routing area (RA) can be handled by many serving nodes of the same or different type. A routing function for deciding to which serving node the connection is to be made, is preferably located in the radio access network (RAN) or the respective network element providing or controlling the radio access. The routing function located in the RAN additionally provides or comprises a method for selection of the serving node to connect to.

This method and structure can be used by the radio access network (or RAN controlling node or component) to find the serving node to be used.

In accordance with one aspect of the invention, a user equipment such as a MS may be adapted to select an operator.

The method and system according to the invention may be used to allow many operators (each owning their own serving node) to share a common Radio Access Network (owned by another operator). If every operator uses a different CN identifier, and if the MSs are configured to always use same CN identifier (even in the very first attach request) based on subscription information typically read from a SIM card, then the MS will always be connected to an SGSN owned by this operator (from which they bought SIM card).

Although preferred embodiments have been described above, the invention is not limited thereto and may also be implemented in networks of different types using serving nodes of different structure such as MSC/VLR.

1-16. (canceled)

17. System for providing an attachment or a connection in a communication network comprising a radio access network and at least two operator networks, the system being adapted to route a connection between a user equipment and another network element via the radio access network, and one or more of alternatively selectable support network elements of the operator networks,
the radio access network being adapted to broadcast information on available operator networks or support network elements to the user equipment, wherein the broadcast information includes information on the mobile generation type of the operator network to which the support network element or elements belong,
the user equipment being adapted to receive the broadcast information and to send selection information to the radio access network for selecting an operator network and/or a support network element,
wherein the broadcast information includes area identifiers of the operator networks, the broadcast area identifiers being specified as information which is only readable by user equipments of the respective generation type, and
wherein the user equipment is adapted to receive only that part of the broadcast information which is intended for the generation type of the user equipment.

18. System according to claim 17, wherein the area identifiers of the operator networks are Location or Routing Area Identifiers (RAIs).

19. System according to claim 17, wherein the broadcast information includes mobile network codes of the operator networks.

20. System according to claim 17, wherein the broadcast information includes mobile network codes of the operator networks, and identifiers for identifying available support network elements.

21. System according to claim 17, wherein the radio access network or selected operator network is adapted to select a support network element and send information on the selected support element to the user equipment.

22. System according to claim 17, wherein the support network elements are serving nodes, preferably SGSNs.

23. System according to claim 17, wherein the radio access network includes a Radio Network Controller or a Base Station Controller.

24. System according to claim 17, wherein at least one of the network elements is adapted to store a list of support network elements of the operator networks, said list identifying the types of support network elements.

25. Method for providing an attachment or a connection in a communication network, wherein a connection is routed between a user equipment and another network element via a radio access network, and one or more of alternatively selectable support network elements of at least two operator networks, the radio access network broadcasting information on available operator networks or support network elements to the user equipment, the broadcast information including information on the generation type of the support network elements,
wherein the broadcast information includes area identifiers of the operator networks, the broadcast area identifiers being specified as information which is only readable by user equipments of the respective generation type, and
wherein the user equipment receives only that part of the broadcast information which is intended for the generation type of the user equipment, and the user equipment sends selection information to the radio access network for selecting an operator network and/or a support network element.

26. Method according to claim 25, wherein the broadcast area identifiers of the operator networks are Location or Routing Area Identifiers (RAIs).

27. Method according to claim 25, wherein the broadcast information includes mobile network codes of the operator networks.

28. Method according to claim 25, wherein the broadcast information includes mobile network codes of the operator networks, and identifiers for identifying available support network elements.

29. Method according to claim 25, wherein the radio access network or selected operator network select a support network element and send information on the selected support element to the user equipment.

30. Method according to claim 25, wherein the support network elements are serving nodes, preferably SGSNs.

31. Method according to claim 25, wherein the radio access network includes a Radio Network Controller or a Base Station Controller.

32. Method according to claim 25, wherein at least one of the network elements stores a list of support network elements of the operator networks, said list identifying the types of support network elements.
